(19) United States
(12) Patent Application Publication
(10) Pub. No.: US 2006/0040701 A1
(43) Pub. Date: Feb. 23, 2006

(54) Beacon group merging

(75) Inventors: Joseph William Long, Albuquerque, NM (US); Aniruddha Rangnekar, Baltimore, MD (US); James Larry Taylor, Epone (FR)

Correspondence Address: VAN PELT, YI & JAMES LLP, 10050 N. FOOTHILL BLVD #200, CUPERTINO, CA, 95014, US

(73) Assignee: Staccato Communications, Inc.

(21) Appl. No.: 11/207,560

(22) Filed: Aug. 18, 2005

Related U.S. Application Data
(60) Provisional application No. 60/602,823, filed on Aug. 18, 2004.

(51) Int. Cl. H04B 7/00

(52) U.S. Cl. 455/525

(57) ABSTRACT

Modifying a scheduled beacon transmission is disclosed. It is determined whether to modify the scheduled beacon transmission. An intent to modify the scheduled beacon transmission is announced, where the intent includes information associated with when modification of the scheduled beacon transmission occurs. The scheduled beacon transmission is modified.

### CROSS REFERENCE TO OTHER APPLICATIONS

This application claims priority to U.S. Provisional Patent Application No. 60/602,823 (Attorney Docket No. AIELP029+) entitled BEACON GROUP MERGING filed Aug. 18, 2004 which is incorporated herein by reference for all purposes.

### BACKGROUND OF THE INVENTION

Beacon frames are used to communicate important information between wireless devices. For example, beacons may contain timing information or reservations for future data transmissions. If a wireless device stops receiving beacons, the wireless device in some cases may not be able to transmit. Within a beacon group, members coordinate beacon frame transmissions to avoid collisions. However, non-member wireless devices may be in the vicinity and cause collisions with the beacon frames. Methods to reduce collisions of beacon frames with non-member wireless devices would be useful.

### BRIEF DESCRIPTION OF THE DRAWINGS

Various embodiments of the invention are disclosed in the following detailed description and the accompanying drawings.

FIG. 1 is a diagram illustrating an embodiment of two beacon groups in the vicinity of each other.

FIG. 2 is a block diagram illustrating an example of a wireless device.

FIG. 3 is a timing diagram illustrating an example of a superframe structure.

FIG. 4A is a timing diagram illustrating an example of two superframe structures with overlapping beacon periods.

FIG. 4B is a timing diagram illustrating an example of two superframe structures with non-overlapping beacon periods.

FIG. 5 is a diagram illustrating an embodiment of a beacon frame.

FIG. 6A is a timing diagram illustrating an example of concatenating to the last occupied beacon slot to determine a beacon transmission schedule for a merged beacon group.

FIG. 6B is a timing diagram illustrating an example of concatenating to determine a beacon transmission schedule for a merged beacon group.

FIG. 7 is a timing diagram illustrating two wireless devices performing a beacon group merge.

FIG. 8 is a flowchart illustrating an embodiment of a beacon group merge.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Modifying a scheduled beacon transmission is disclosed. The scheduled beacon transmission may be associated with a member of a beacon group. A determination whether to modify the scheduled beacon transmission occurs. For example, a wireless device may detect the presence of another beacon group and decide to change its scheduled beacon transmission. An intent to modify the scheduled beacon transmission is announced, including when the modification occurs. In some embodiments, a wireless device transmits a beacon switch information element to indicate its intent and a countdown in the information element indicates when the modification occurs. The scheduled beacon transmission is modified. In some embodiments, the modification includes adopting a beacon period start time of another beacon group.

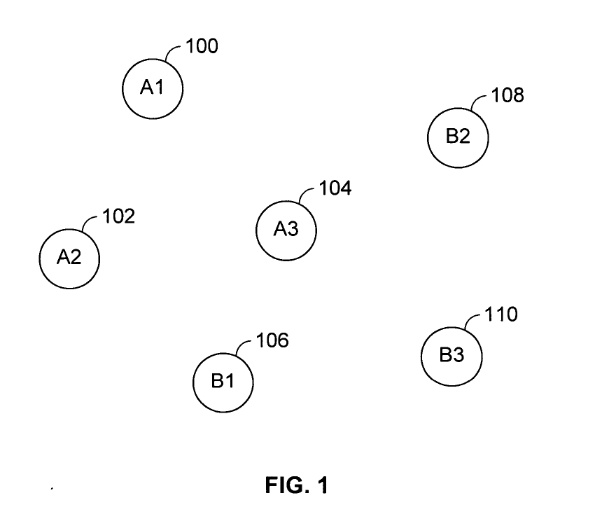

FIG. 1 is a diagram illustrating an embodiment of two beacon groups in the vicinity of each other. In the example shown, each beacon group has three wireless devices as members. Wireless devices A1 100, A2 102, and A3 104 are members of one beacon group. The other beacon group includes B1 106, B2 108, and B3 110. Each member of each beacon group transmits beacons in this example. That is, responsibility for beacon transmission is distributed amongst members of the beacon group. Within each beacon group, transmissions of beacon frames are coordinated to avoid collisions. Members of a beacon group may agree to not transmit at a designated time so a member may transmit a beacon. Coordination of beacon transmissions may be described by a beacon transmission schedule. Members transmit beacons according to the schedule and do not transmit during scheduled beacon transmission times that are not theirs. In some embodiments, a beacon transmission schedule is described in predefined units of time, such as a beacon slot. In some embodiments, a beacon transmission schedule includes unoccupied beacon slots where no member of a wireless group is scheduled to transmit a beacon.

If two beacon groups are in the vicinity of each other, collisions with beacon transmissions may occur because beacon transmissions are not coordinated between the two groups. A beacon from one group may collide with a beacon or a non-beacon transmission from the other group. This may be the result of a change in the wireless transmission environment. For example, a barrier that blocked transmissions between the two beacon groups may be removed. A member of a beacon group may also move into the vicinity of another beacon group. For example, A3 104 may move away from members of beacon group A, A1 100 and A2 102, and towards members of beacon group B. Beacons transmitted by A3 104 may begin to collide with transmissions from beacon group B as A3 104 moves closer to beacon group B. A beacon group that is not the beacon group of a given wireless device is referred to as an alien beacon group. For example, beacon group B is an alien beacon group with respect to any wireless device of beacon group A and vice versa.

Beacons may contain important information, such as timing information and resource allocation information. A receiving wireless device may use a beacon to detect the presence of other wireless stations. In some embodiments, if too many beacon collisions occur, a wireless device may not be able to transmit. Beacon collisions may be detrimental to a beacon group.

Collisions with beacon transmissions of two beacon groups may be resolved by merging two beacon groups. At the beacon group level, members of beacon groups A and B use a common beacon transmission schedule so that beacon transmissions do not collide with other transmissions, both beacon and non-beacon, from member wireless devices. A wireless device performing a beacon group merge may change its scheduled beacon transmission based on the common beacon transmission schedule. In some embodiments, the common beacon transmission schedule may be new with respect to both beacon groups. The common beacon transmission schedule in some embodiments is based on one of the original beacon transmission schedules. For example, one beacon group may adopt timing based on the other beacon group's beacon transmission schedule.

The beacon group merging process may be distributed. Each wireless device may independently detect the presence of wireless devices from alien beacon groups, decide whether or not to merge beacon groups, and perform a beacon group merge. For example, B1 106 and A3 104 may detect the presence of each other. A decision is made at each device to merge beacon groups and a common beacon transmission schedule is adopted. This process repeats for A2 102 and B2 108, as well as A1 100 and B3 110. The process may be distributed and detection of an alien beacon group, deciding whether to perform a beacon group merge, and performing a beacon group merge may ripple outward. In some embodiments, the process is centralized. In some embodiments, the process is distributed but coordinated. For example, A1 100 may not have detected an alien beacon group but A3 104 announces it plans to perform a beacon group merge and change its scheduled beacon transmission. A1 100 may decide to perform a beacon group merge as well. In some embodiments, A1 100 implements the change of its scheduled beacon transmission to coincide with A3 104.

A wireless device may be an Ultra Wideband (UWB) device. UWB devices use frequency bands with large bandwidths, for example on the order of hundreds of MHz. A wireless device may use frequency hopping and change the frequency band used to exchange information with another wireless device. Changing the frequency band may occur in the middle of transmitting a frame or between frame transmissions. Devices based on an IEEE 802.15.3a related proposal and WiMedia devices are some example UWB wireless devices. In some embodiments, a wireless device is a narrowband device. For example, an IEEE 802.11 device, which may be referred to as a WiFi device, may be one of the illustrated wireless devices.

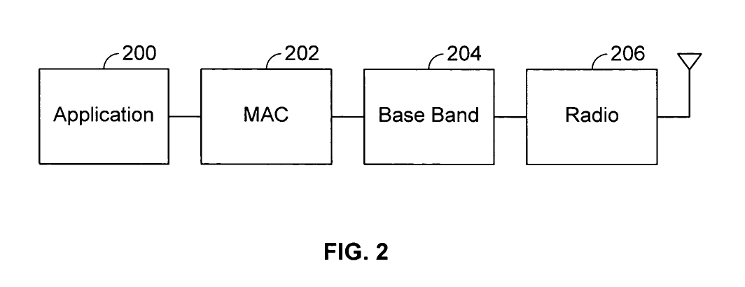

FIG. 2 is a block diagram illustrating an example of a wireless device. In the example shown, the wireless device may be an Ultra Wideband (UWB) wireless device. Application 200 is coupled to Media Access Control (MAC) 202. Application 200 may include intermediate protocol layers such as a transport layer or a network layer. Application 200 may have data, control, or management information to exchange with a counterpart application running on another wireless device. This information may be exchanged over a wireless transmission channel using MAC 202, baseband 204, and radio 206. MAC 202 may control access to the wireless transmission channel. Baseband 204 is coupled to MAC 202 and may perform encoding and modulation processes on frames from MAC 202. Analog I and Q signals may be passed from baseband 204 to radio 206 where they are transmitted in the appropriate frequency spectrum. Corresponding inverse functions may be performed for the receive path.

Control of beacon group merging may be performed by a MAC. For example, MAC 202 may receive a beacon frame and detect the presence of another beacon group using the received beacon. MAC 202 may decide whether or not to merge beacon groups. A decision may be made immediately after detection of an alien beacon group, or MAC 202 may wait to make a decision. Additional information may be collected by the MAC during this time. If MAC 202 decides to perform a beacon group merge, MAC 202 may perform functions to implement the merge. For example, a new scheduled beacon transmission time may be determined by the MAC. In some embodiments, a wireless device announces its intent to merge beacon groups before the merge occurs. MAC 202 may be responsible for transmitting this information. A dedicated frame or a field in a frame may be used to announce an intent to merge beacon groups. A time at which the beacon group merge will occur may be included.

Other entities in place of or in addition to a MAC may perform functions associated with beacon group merging. For example, MAC 202 may request input from application 200 when deciding whether to merge beacon groups. Input from application 200 may include approval for a beacon group merge or a suggested time for a beacon group merge to occur. Application 200 may possess more knowledge of the state of the wireless device than MAC 202. For example, the application may currently be exchanging important data with another application and may not want to interrupt the data exchange. In some embodiments, detection of an alien beacon group, deciding whether to perform a beacon group merge, and performing the beacon group merge are performed by an application. In some embodiments, multiple entities are responsible. For example, MAC 202 may detect an alien beacon group and implement a beacon group merge, but application 200 may perform the decision making.

In some embodiments, a criterion is used to determine a beacon group merge is to occur. For example, a criterion may be used to avoid performing a beacon group merge in the presence of a transient alien beacon group. The transient alien beacon group may be moving past a beacon group and a beacon group merge may not be necessary. The criterion may include a threshold. A wireless device may have to receive beacons for at least a time threshold. Or, a wireless device may have to receive a certain number of beacons from an alien beacon group. A decision whether to perform a beacon group merge in some embodiments is not made immediately after an alien beacon group is detected.

Beacon group merging may be transparent to some entities. For example, a beacon group merge may be transparent to an application. A MAC may be responsible for managing beacon group merging. Although the MAC may decide and implement a beacon group merge, an application may be unaware of the beacon group merging process. The upper layer application in some embodiments may not consider itself associated, joined, or networked with some members of its beacon group even after a beacon group merge is performed. Merging beacon groups may be only with respect to coordinating beacon transmissions. Beacon group merging may be transparent to and independent of other functions (such as joining a network, authenticating another wireless device, or exchanging data) and transparent to other entities (such as an upper layer application). In some embodiments, beacon group merging is coupled with merging a group other than the beacon group. For example, beacon group merging may be coupled with authenticating and associating with another wireless device.

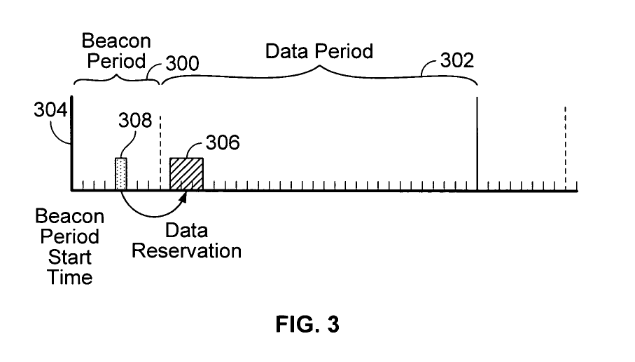

FIG. 3 is a timing diagram illustrating an example of a superframe structure. In the example shown, the superframe structure is repeated and defines time periods associated with certain functions. In some embodiments, the duration of the superframe is fixed and all beacon groups have the same superframe duration. Each wireless device within a beacon group is responsible for tracking the timing of the superframe structure. Beacon period 300 is used to transmit beacons. A beacon period is defined by beacon period start time 304 (which is also the start of the superframe in this example) and the beacon period duration. In this example, the beacon period duration is 8 beacon slots. In some embodiments, the beacon period duration is flexible. For example, each beacon group may determine the beacon period duration depending on the number of members a beacon group has.

Beacon transmissions between members of a beacon group may be coordinated with respect to beacon slots. For example, each member of a beacon group may be scheduled to transmit during a different beacon slot. A new wireless device joining a beacon group may listen to determine the beacon period start time, determine unoccupied beacon slots, and join a beacon group using an unoccupied beacon slot. In some cases, occupied beacon slots are not contiguous within the beacon period. A beacon transmission schedule may describe which member transmits in which beacon slot.

The superframe structure is repeated to create common timing used by all member devices of a beacon group. A wireless device occupying the fifth beacon slot of the beacon period is scheduled to transmit its beacon in the fifth beacon slot of every superframe. The exact contents of beacons transmitted by a wireless device may vary from superframe to superframe, but the scheduled transmission time with respect to the beacon period start time may remain the same.

Data period 302 is used to exchange information between wireless devices and is defined by the end of beacon period 300 and the end of the superframe structure. Data, management, and control information are some examples of the information that may be exchanged during data period 302. In this example, data reservation 306 is made using transmitted beacon 308. A data reservation is a reserved period of time. In some embodiments, data reservation 306 uses a distributed reservation protocol (DRP). A wireless device may use data reservation 306 to transmit high priority information. Data period 302 is divided up into medium access slots. Data reservation 306 may described by the beginning medium access slot and the duration of the reservation. For example, transmitted beacon 308 may described by data reservation 306 as beginning in the second medium access slot of data period 302 and lasting for 3 medium access slots. In some embodiments, beacon slots and medium access slots are not the same duration. In some embodiments, the durations are the same. Although a wireless device may own a data reservation, some or all of the reserved time may not be used by a reserving wireless device. For example, the purpose of the data reservation may be to prevent some wireless devices from transmitting, not necessarily for the reserving wireless device to transmit.

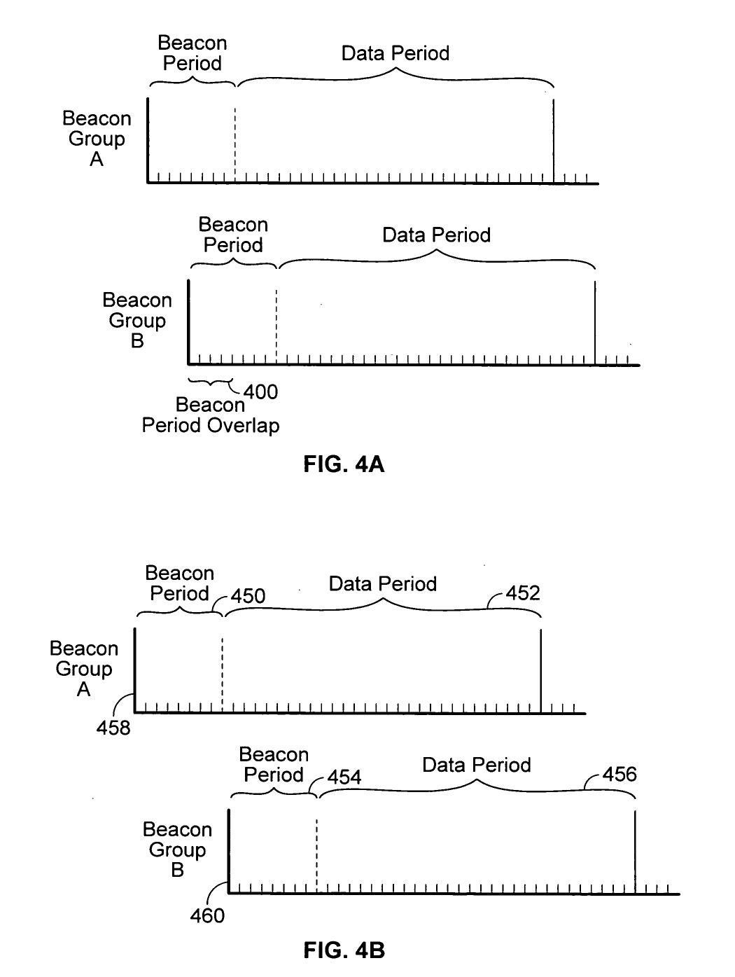

FIG. 4A is a timing diagram illustrating an example of two superframe structures with overlapping beacon periods. In example shown, beacon group A and beacon group B have the same superframe duration, but have different beacon period start times. In this example, wireless devices listen and then join a beacon group. If no beacon group is detected, the wireless device starts a new beacon group. The members that started beacon groups A and B may not have detected the other beacon group and two beacon groups are created. In this example, the beacon periods overlap during time period 400. Although this example illustrates two beacon groups with the same beacon period duration, in some embodiments the beacon period durations are not the same.

FIG. 4B is a timing diagram illustrating an example of two superframe structures with non-overlapping beacon periods. In example shown, beacon group A and beacon group B have the same superframe duration. The two beacon groups do not have the same beacon period start time and their beacon periods do not overlap. Beacon period 454 is within data period 452 and beacon period 450 is within data period 456 in the context of the superframe structure. Another way to describe the non-overlapping beacon periods is that beacon period start times 458 and 460 do not fall within beacon periods 454 and 450, respectively.

Decision making and/or the time at which events occur may depend on whether the beacon periods overlap. For example, situations in which beacon periods overlap may be considered more detrimental than if the beacon periods do not overlap. During the beacon period overlap, beacon transmissions for both beacon groups may be corrupted. Expedited beacon group merging may be performed in such cases. A wireless device may immediately decide to merge beacon groups if the beacon periods overlap. Conversely, if the beacon periods do not overlap, a wireless device may wait to obtain more information before deciding whether to merge beacon groups. After deciding to implement a beacon group merge, a wireless device may perform the merge with little or no waiting compared to non-overlapping beacon periods. For example, if the beacon periods do not overlap, the wireless device may wait some number of superframes after a deciding to perform a beacon group merge before actually performing the beacon group merge. If the beacon periods do overlap, a wireless device may implement the change at the next possible opportunity.

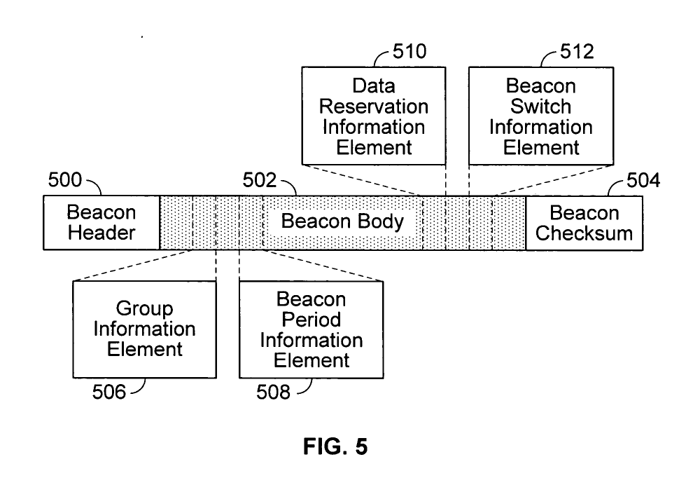

FIG. 5 is a diagram illustrating an embodiment of a beacon frame. In the example shown, a beacon frame includes beacon header 500, beacon body 502, and beacon checksum 504. Beacon header 500 may be used to identify the frame as a beacon type frame and may include address information, such as the address of the transmitting wireless device. Beacon checksum 504 may be used to detect errors in a received beacon frame. An example of beacon checksum 504 is a frame check sequence (FCS). Beacon body 502 includes a variety of information elements. In some embodiments, the information elements included in a transmitted beacon vary from beacon to beacon. For example, a transmitting wireless device may transmit a given information element only under certain circumstances. Otherwise, the information element may not be included in the beacon body.

Beacon body 502 may be used to disseminate management and control information. Each information field may contain related information. For example, group information element 506 may include general information associated with the beacon group. Group information element 506 may include the number of members in a beacon group observed by the wireless device transmitting a beacon frame.

Information relating to the beacon period may be included in beacon period information element 508. For example, the beacon period start time and the beacon period duration may be included in the beacon period information element. The beacon slot occupied by the transmitting wireless device and beacon slots occupied by other wireless devices, as perceived by the transmitting wireless device, may also be reported in the beacon period information element. A receiving wireless device may be able to detect a difference between its beacon period start time and the transmitting wireless device's beacon period start time. An alien beacon group may be detected using such a difference between beacon period start times.

Data reservation information element 510 may be used by a transmitting wireless device to reserve a period of time in the data period. Data reservation information element 510 may include the beginning and the duration of the data reservation. Units may be in time or in medium access slots. A reserving wireless device may use the reserved period of time to transmit. However, a reserving wireless device is not required to transmit during its data reservation period.

In some embodiments, a wireless device uses the data reservation information element to protect the beacon period of an alien beacon group. For example, a wireless device may detect an alien beacon group. Detection of the alien beacon group may be performed by comparing beacon period start times using a beacon period information element. The detecting wireless station may transmit a data reservation information element in its beacon to protect the beacon period of the detected alien beacon group. The data reservation information element transmitted may include a data reservation start time roughly corresponding to the alien beacon group's beacon period start time and a data reservation duration corresponding to the alien beacon group's beacon period duration. The data reservation duration may include extra slots since slot boundaries between two beacon groups may not align exactly.

Data reservations in some embodiments have a variety of reservation types. A wireless device in such cases may use the highest priority data reservation to protect an alien beacon group's beacon period. A data reservation type may be selected so that a receiving wireless device respects the data reservation and does not transmit during the alien beacon group's beacon period. A data reservation may explicitly indicate the data reservation is associated with protecting a beacon period, or the data reservation may be a high priority type and not indicate the data reservation is associated with protecting a beacon period.

Beacon body 502 includes beacon switch information element 512. Beacon switch information element 512 may be used by a transmitting wireless device to announce an intent to merge beacon groups. In some embodiments, a beacon group merge is performed by having one beacon group adopt another beacon group's beacon period start time. The beacon switch information element, in some embodiments, is only transmitted by a wireless device of the submissive beacon group. In other words, a wireless device that detects an alien beacon group but determines that its beacon period start time will be adopted may not transmit a beacon switch information element in some embodiments. A beacon group that adopts another beacon group's beacon period start time may be referred to as the submissive beacon group, and a beacon group that has its beacon period start time adopted may be referred to as the dominant beacon group. Beacon switch information element 512 may include a countdown to implementing the beacon group merge. A beacon period start time offset and a beacon slot offset may be included in the beacon switch information element. The beacon period start time offset is the offset between the beacon period start times of the two beacon groups. The beacon slot offset is the offset between the current occupied beacon slot (with respect to the current beacon period start time) and the new occupied beacon slot (with respect to the new beacon period start time) for a wireless device.

In one example of transmitting the beacon switch information element, a wireless device detects the presence of an alien beacon group by receiving a beacon frame or examining the information elements of the beacon frame. In some cases, the time at which a beacon is received may be used to detect an alien beacon group. The receiving wireless device determines it is a member of the submissive beacon group. The beacon transmission schedule of the submissive group is concatenated to that of the dominant beacon group. The submissive wireless device transmits a beacon switch information element in its beacon that includes a countdown to implementing the beacon group merge, a beacon period start time offset, and a beacon slot offset.

Data reservations held by a submissive wireless device may be affected by a beacon group merge. A data reservation held by a dominant wireless device may be affected by a beacon group merge as well. In some embodiments, data reservations of the dominant beacon group are maintained at the expense of data reservations of the submissive beacon group. A data reservation associated with the submissive group may also conflict with the new beacon period. If a data reservation is affected (either by a data reservation held by a dominant wireless device or the new beacon period), a submissive wireless device may use the countdown period to move or adjust its data reservation to an available portion of the data period. In some embodiments, multiple members of the submissive beacon group are performing a beacon group merge. A wireless device may negotiate with other wireless devices in the process of adjusting its data reservations. An entity within a wireless device, such as an application or MAC, may adjust a data reservation. Similarly, a dominant wireless device may adjust an affected data reservation during a countdown.

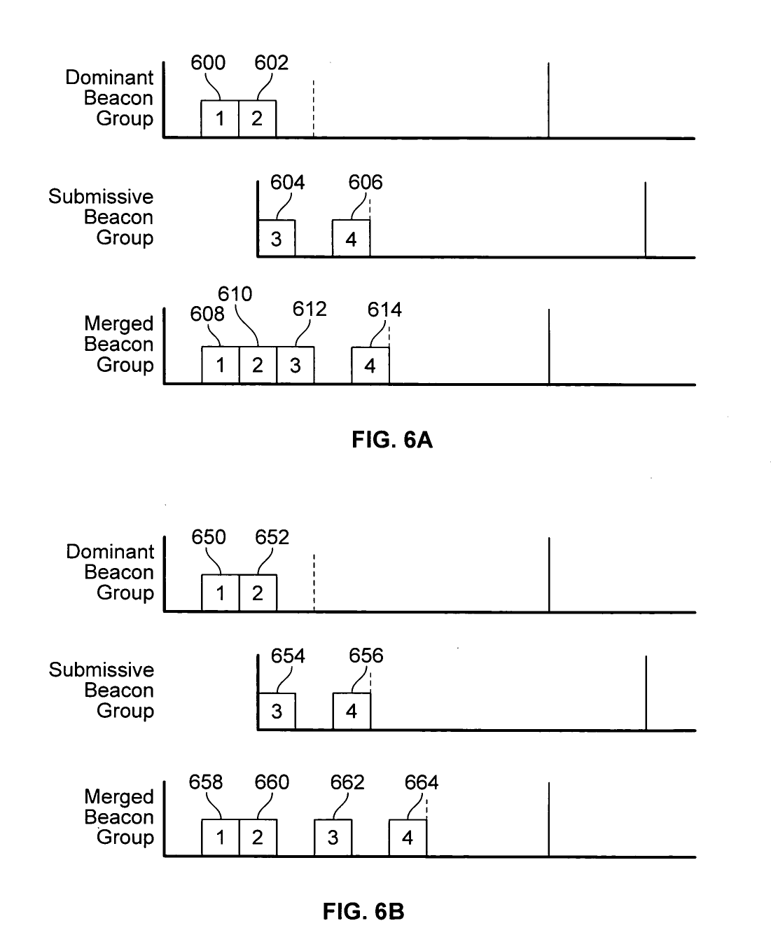

FIG. 6A is a timing diagram illustrating an example of concatenating to the last occupied beacon slot to determine a beacon transmission schedule for a merged beacon group. In the example shown, a dominant beacon group and a submissive beacon group are merged. The beacon period start time of the dominant beacon group is used as the beacon period start time of the merged beacon group. Occupied beacon slots 600 and 602 are in the second and third beacon slots, respectively, of the dominant beacon group's beacon period. The first and third beacon slots of the submissive beacon group contain occupied slots 604 and 606. Occupied beacon slots are used by a wireless device to transmit a beacon. For example, a wireless device A1 of the dominant beacon group (not shown) may use occupied slot 600 every superframe to transmit its beacon.

In the example shown, the beacon transmission schedule of the submissive beacon group is concatenated to the last occupied beacon slot of the dominant beacon group. Occupied beacon slots 608 and 610 have the same relative positioning with respect to each other compared to occupied beacon slots 600 and 602. Similarly, occupied beacon slots 612 and 614 have the same relative positioning with respect to each other compared to occupied beacon slots 604 and 606. The unoccupied beacon slot between slots 604 and 606 is maintained between slots 612 and 614. The beacon period duration of the merged beacon group in this example is the number of the last occupied beacon slot in the dominant group plus the beacon period duration of the submissive beacon group. In the example illustrated, this is 3 (slot number of last occupied slot 602) +3 (beacon period duration of the submissive beacon group)=6. This process may be used by each member of the submissive group to modify its scheduled beacon transmission time in a distributed manner.

FIG. 6B is a timing diagram illustrating an example of concatenating to determine a beacon transmission schedule for a merged beacon group. In the example shown, the beacon transmission schedules of the submissive beacon group and dominant beacon group are concatenated. Occupied beacon slots 658 and 660 correspond to occupied slots 650 and 652, respectively. Occupied beacon slots 662 and 664 correspond to occupied beacon slots 654 and 656. An unoccupied beacon slot is maintained after slot 660, corresponding to the unoccupied beacon slot after slot 652. The beacon period duration of the merged beacon group is the sum of the beacon period durations of the dominant and submissive beacons groups. This process may be distributed where each wireless device in a submissive beacon group uses this process to modify its scheduled beacon transmission time.

Other methods may be used to determine the beacon transmission sequence of a merged beacon group. In some embodiments, the order of concatenation is reversed. The beacon transmission schedule of the dominant beacon group may be concatenated to the end of the submissive beacon group's beacon transmission schedule. In some embodiments, unoccupied beacon slots are removed. For example, the first beacon slot of the merged beacon group may correspond to occupied beacon slot 600 instead of being unoccupied. Other unoccupied beacon slots (for example, in the middle of beacon period) may be removed in determining a merged beacon group's beacon transmission schedule. In some embodiments, members of the dominant beacon group and submissive beacon group are interleaved in the beacon transmission schedule of the merged beacon group.

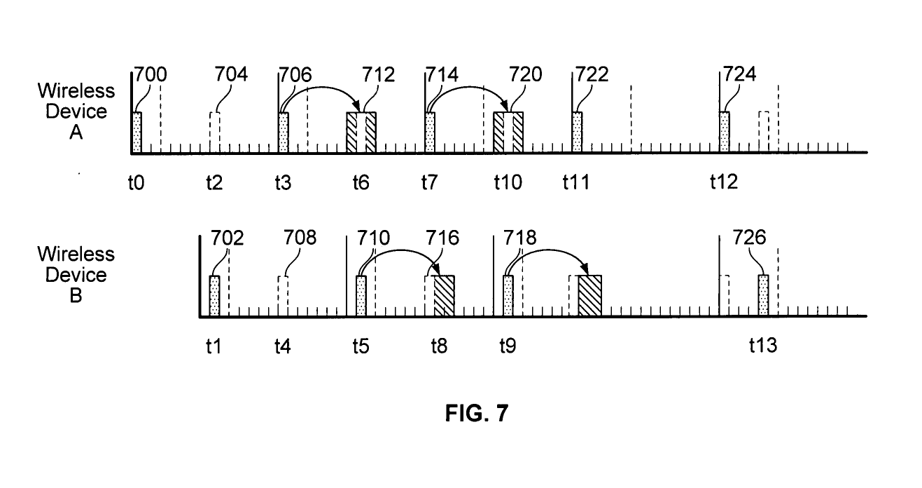

FIG. 7 is a timing diagram illustrating two wireless devices performing a beacon group merge. In the example shown, wireless devices A and B are members of different beacon groups. There may be other members of the beacon groups in addition to wireless devices A and B. At t0, wireless device A transmits beacon 700. The first beacon slot is occupied by wireless device A, and a beacon is transmitted by wireless device A in that slot every superframe. At time t1, wireless device B transmits beacon 702. Transmitted beacon 702 is received at time t2 as received beacon 704. Wireless device A examines received beacon 704 and determines that the transmitting wireless device is a member of an alien beacon group. For example, it may evaluate information elements in received beacon 704 and determine that the beacon period start time of received beacon 704 is different than its beacon period start time.

After wireless device A detects the presence of an alien beacon group, wireless device A determines if it is part of the dominant beacon group or the submissive beacon group. In this example, the beacon group with an earlier beacon period start time is the dominant beacon group. That is, the beacon period start time of the submissive beacon group falls within the first half of the dominant beacon group's superframe. The superframe durations of all beacon groups are equal in this example. Since the beacon period start time of wireless device B falls within the first half of wireless device A's superframe, wireless device B is a member of the submissive beacon group. In some embodiments, different methods may be used to determine the dominant and submissive beacon groups.

Wireless device A transmits beacon 706 at t3. To protect the beacon period of the alien beacon group, transmitted beacon 706 includes a data reservation. The data reservation begins at the beacon period start time of wireless device B and lasts for the duration of the wireless device B's beacon period.

The transmitted beacon is received at t4 as received beacon 708. Wireless device B examines the information elements of received beacon 708 and determines that the beacon period start time included is different than its own beacon period start time. An alien beacon group is detected by wireless device B. By comparing the beacon period start times, wireless device B determines it is a member of the submissive beacon group. Wireless device B will adopt the beacon period start time of wireless device A.

As a member of the submissive beacon group, wireless device B is responsible for changing data reservations affected by the beacon group merge. For example, wireless device B may have to move a data reservation that coincides with the new beacon period. A data reservation held by wireless device B may also conflict with a data reservation held by a member of the dominant submissive group. Data reservations held by members of the dominant beacon group may be determined by examining the data reservation information element in received beacon 708. Wireless device B may move or change conflicting data reservations held by wireless device B while counting down to performing the beacon group merge.

Wireless device B transmits beacon 710 at t5 with a data reservation to protect the beacon period of wireless device A. Beacon 710 also includes the intent of wireless device B to perform a beacon merge. A beacon switch information element may be included in beacon 710 to communicate this intent. For example, a countdown value of 1 is included, indicating when the beacon group merge will occur. A beacon period start time offset and a beacon slot offset are also included in beacon 710.

Beacon 710 is received by wireless device A at t6 as received beacon 712. Beacon 712 is received during a data reservation communicated via beacon 706. The beacon switch information element included in received beacon 712 may be analyzed by wireless device A for conflicting data reservations held by wireless device A. For example, wireless device B may announce its intent to occupy the fifth beacon slot after adopting the dominant beacon period start time. Wireless device A may have a data reservation that includes this slot and may move its data reservation to available medium access slots.

At t7, beacon 714 is transmitted by wireless device A. In anticipation of the beacon merge, the beacon period duration is expanded. The new beacon period duration in this example is the sum of the beacon period durations of the submissive and dominant beacon groups. Beacon 714 also includes a data reservation to protect the submissive beacon period. Wireless device B receives beacon 716 at time t8. A data reservation made by beacon 710 includes received beacon 716.

A countdown value of 0 is included in beacon 718 transmitted at t9. The countdown value of 0 may be used to indicate that wireless device B intends to merge beacon groups on its next beacon transmission. Beacon 718 also includes a data reservation to protect the beacon period of the dominant beacon group. Wireless device receives beacon 720 at t10 during a data reservation.

Beacon 722 is transmitted at t11. No data reservation is included in transmitted beacon 722 since the next beacon transmitted by wireless device B will be transmitted after the beacon group merge is performed. Wireless device A transmits beacon 724 at t12 in the first beacon slot of the beacon period. At t13, wireless device B transmits beacon 726 in the fifth beacon slot of the beacon period. This is the first superframe after beacon group merging is performed. Both wireless devices A and B are using the same beacon period start time, using the same beacon period, and have coordinated their beacon transmissions.

Different methods may be used besides those that illustrated in the previous example. The beacon group with the later beacon period start time may be the dominant beacon group. In some embodiments, another method is used to determine the dominant and submissive beacon groups. For example, the number of members in each beacon group may be considered. The beacon group with more members may be the dominant beacon group. The number of data reservations held by members of each beacon group may be considered. The beacon group with more data reservations may be the dominant beacon group. This may reduce the number of data reservations affected by merging beacon groups.

In some embodiments, the timing of certain events varies from that illustrated. For example, when the countdown equals 0, rather than transmitting its first beacon using the new beacon period start time at time t13, wireless device B may transmit after beacon 722. Conversely, wireless device B may indicate a countdown of 0 and wait longer to transmit its first beacon using the new beacon period start time than that illustrated. The expansion of the beacon period by wireless device A may occur at a different time in some embodiments. Instead of increasing the beacon period duration after transmitted beacon 714, wireless device may wait until beacon 722 or beacon 724 to increase the beacon period duration. In some embodiments, a wireless device waits some time before deciding and announcing its intent to perform a beacon group merge. For example, wireless device B may wait to receive more beacons from wireless device A before deciding to perform a beacon group merge. Wireless device B may wait to receive two beacons from wireless device A and not announce its intent to perform a beacon group merge until beacon 718.

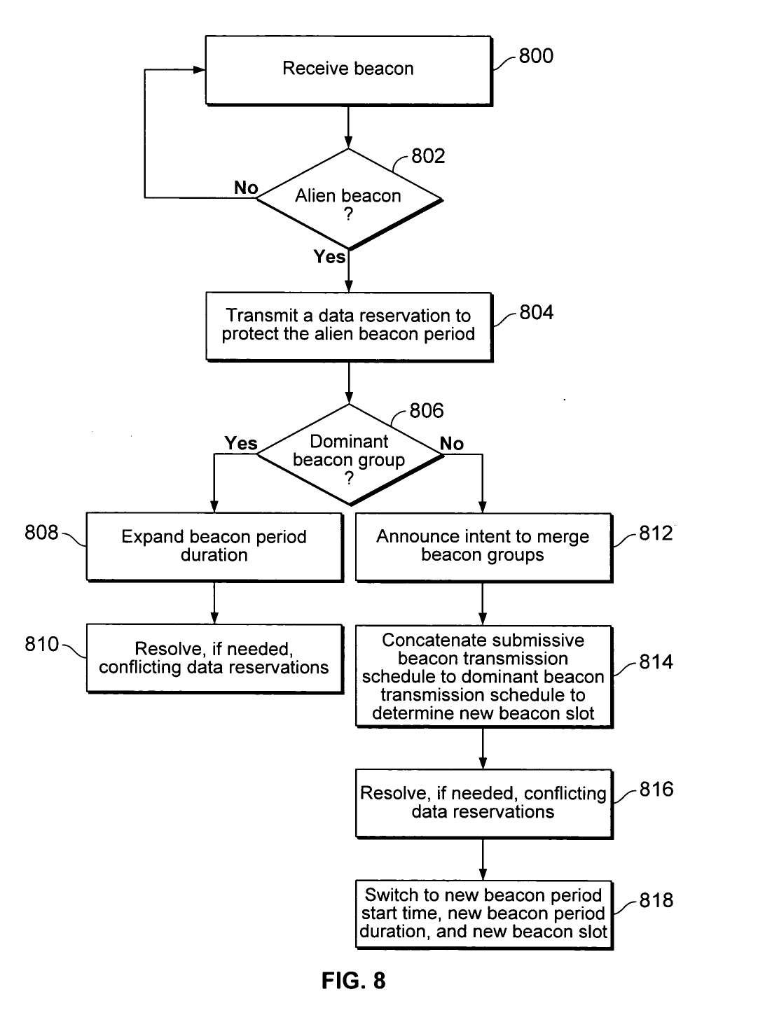

FIG. 8 is a flowchart illustrating an embodiment of a beacon group merge. In the example shown, a beacon is received at 800. A decision is made at 802 if it is an alien beacon. Information elements included in the received beacon may be evaluated to determine if the beacon is from an alien beacon group. If the beacon is not an alien beacon, the process returns to 800 to receive a beacon. If it is an alien beacon, a data reservation is transmitted to protect the alien beacon period at 804. A data reservation included in a transmitted beacon may be used to prevent other wireless devices from interfering with beacon transmissions of the alien beacon group.

A decision is made at 806 if it is the dominant beacon group. A variety of tests may be used to determine the dominant beacon group. For example, the beacon period start times, the number of members in a beacon group, or the number of data reservations may be used. If it is the dominant beacon group, the beacon period duration is expanded at 808. A wireless device that is a member of the dominant beacon group maintains its beacon period start time and expands the beacon period duration to include members of the submissive beacon group. At 810, conflicting data reservations are resolved, if needed. For example, a dominant wireless device may own a data reservation that is affected by the expanded beacon period duration.

If it is not the dominant beacon group, the intent to merge beacon groups is announced at 812. A beacon switch information element may be included in a transmitted beacon to announce this intent. Wireless devices that receive a beacon with the beacon switch information element know the transmitting device intends to merge beacon groups. At 814, the submissive beacon group transmission schedule is concatenated to the dominant beacon transmission schedule to determine a new beacon slot. For example, a wireless device may occupy the first beacon slot in a submissive beacon group. After the beacon merge, the wireless device occupies the first beacon slot after the dominant beacon transmission schedule.

If needed, conflicting data reservations are resolved at 816. For example, the submissive wireless device may own a data reservation that conflicts with the new beacon period or with a data reservation owned by a dominant wireless device. The conflicting data reservation may be resolved by changing the data reservation to unoccupied medium access slots or by canceling the data reservation. In some embodiments, this process occurs over multiple superframes. A beacon group merge may not occur immediately and the submissive wireless device may have some time to resolve the conflicting data reservations.

At 818, a switch to a new beacon period start time, a new beacon period duration, and a new beacon slot occurs. In some embodiments, a countdown is included in a beacon switch information element transmitted in a beacon frame. The switch may occur after the countdown reaches 0. In some embodiments, the switch occurs with little or no warning. For example, situations in which two beacon periods overlap may be considered more detrimental than if the beacon periods do not overlap. If beacon periods overlap, the beacon group merge may occur at the next beacon period start time of the dominant device. Or, the first beacon with a beacon switch information element may have a countdown value of 0.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of modifying a scheduled beacon transmission including:
determining whether to modify the scheduled beacon transmission;
announcing an intent to modify the scheduled beacon transmission, wherein the intent includes information associated with when modification of the scheduled beacon transmission occurs; and
modifying the scheduled beacon transmission.

2. A method as recited in claim 1, wherein a plurality of members of a beacon group transmit a beacon.

3. A method as recited in claim 1, wherein a beacon is used to announce the intent.

4. A method as recited in claim 1, wherein modifying includes modifying a beacon period start time.

5. A method as recited in claim 1, wherein modifying includes modifying a beacon period duration.

6. A method as recited in claim 1 further including protecting a beacon period associated with another beacon group.

7. A method as recited in claim 1 further including protecting a beacon period associated with another beacon group, wherein protecting includes conveying a reservation obeyed by a receiver of the reservation.

8. A method as recited in claim 1, wherein determining includes counting received beacons.

9. A method as recited in claim 1, wherein determining includes recording a time at which a beacon is received.

10. A method as recited in claim 1, wherein in the event a first beacon period overlaps with a second beacon period, modifying the scheduled beacon transmission is imminent.

11. A method as recited in claim 1, wherein in the event a first beacon period does not overlap with a second beacon period, modifying the scheduled beacon transmission is at least one superframe duration away.

12. A method as recited in claim 1, wherein modifying includes concatenating a first sequence of scheduled beacon transmission times with a second sequence of scheduled beacon transmission times.

13. A method as recited in claim 1, wherein modifying the scheduled beacon transmission is transparent to an upper layer application.

14. A method as recited in claim 1, wherein receiving the intent triggers a determination at a receiver to modify the receiver's scheduled beacon transmission.

15. A method as recited in claim 1, wherein the intent is propagated by a receiver of the intent.

16. A system for modifying a scheduled beacon transmission including:
a processor configured to
determine whether to modify the scheduled beacon transmission; and
modify the scheduled beacon transmission; and
an interface configured to announce an intent to modify the scheduled beacon transmission, wherein the intent includes information associated with when modification of the scheduled beacon transmission occurs; and

17. A system as recited in claim 16, wherein the interface is further configured to protect a beacon period associated with another beacon group.

18. A system as recited in claim 16, wherein determining includes counting received beacons.

19. A system as recited in claim 16, wherein in the event a first beacon period overlaps with a second beacon period, modifying the scheduled beacon transmission is imminent.

20. A system as recited in claim 16, wherein modifying includes concatenating a first sequence of scheduled beacon transmission times with a second sequence of scheduled beacon transmission times.

21. A system as recited in claim 16, wherein modifying the scheduled beacon transmission is transparent to an upper layer application.

22. A computer program product for modifying a scheduled beacon transmission, the computer program product being embodied in a computer readable medium and comprising computer instructions for:
determining whether to modify the scheduled beacon transmission;
announcing an intent to modify the scheduled beacon transmission, wherein the intent includes information associated with when modification of the scheduled beacon transmission occurs; and
modifying the scheduled beacon transmission.

23. A computer program product as recited in claim 22, the computer program product further comprising computer instructions for protecting a beacon period associated with another beacon group.

24. A computer program product as recited in claim 22, wherein determining includes counting received beacons.

25. A computer program product as recited in claim 22, wherein in the event a first beacon period overlaps with a second beacon period, modifying the scheduled beacon transmission is imminent.

26. A computer program product as recited in claim 22, wherein modifying includes concatenating a first sequence of scheduled beacon transmission times with a second sequence of scheduled beacon transmission times.

27. A computer program product as recited in claim 22, wherein modifying the scheduled beacon transmission is transparent to an upper layer application.
